(19) United States
(12) Patent Application Publication
(10) Pub. No.: US 2016/0119593 A1
(43) Pub. Date: Apr. 28, 2016

(54) MOBILE CONSOLE

(71) Applicant: Nurep, Inc., San Jose, CA (US)

(72) Inventors: David Paul Schultz, San Jose, CA (US); Sainath Shenoy, San Jose, CA (US); Steven Kim, San Jose, CA (US); Adam Daniel John, San Jose, CA (US)

(21) Appl. No.: 14/922,381

(22) Filed: Oct. 26, 2015

Related U.S. Application Data
(60) Provisional application No. 62/051,526, filed on Oct. 24, 2014.

(51) Int. Cl. H04N 7/18; H04N 5/232; H04N 5/225; B62B 3/02

(52) U.S. Cl. CPC H04N 7/185; B62B 3/022; H04N 5/23296; H04N 5/2251

(57) ABSTRACT

A mobile floor standing console with a wheeled base, a lower rack mounted on the base, an upper rack extending vertically from the lower rack, a first articulating arm that is configured to extend outward away from the upper rack and collapse inward toward the upper rack, a second articulating arm that is configured to extend outward away from the upper rack and collapse inward toward the upper rack, a video camera attached to the second articulating arm, and a tablet personal computer attached to the first articulating arm; the console configured to be readily mobilized on the floor of an existing operating room and is capable of providing a connectivity point for communication, audiovisual, and data transfer services in the operating room.

### CROSS-REFERENCE TO RELATED APPLICATIONS

This application claims the benefit of U.S. Provisional Patent Application No. 62/051,526, filed Oct. 24, 2014, which is incorporated herein by reference in its entirety.

### BACKGROUND

1. Field of the Invention

This disclosure relates to remotely demonstrating medical devices and, more specifically, to a portable, floor standing console configured to support and position electronic displays and video camera equipment for use in the vicinity of the operating table and surgical field.

2. Description of the Related Art

Typically, in the performance of surgery on a patient, a 3D video camera is placed in or above the surgical area of the patient. The image from the camera can then be transmitted to a large display, such as a flat panel to provide an enlarged view of the surgical field for the operating doctor, as well as other doctors and staff in the operating room.

The current trend in hospital operating rooms is not limited to the use of a camera, though. State of the art hospital operating rooms now contain, in addition to video cameras, a wide variety of audio, visual and technology tools, video recorders, speakers, microphones and voice recorders, video guided ultrasound imaging systems, and lasers, just to name a few of these tools. To accommodate all the audio, visual and medical equipment, many operating rooms have been built or retrofitted to include one or more booms suspended from the ceiling. The audio and visual equipment is then hung from the booms over the operating table.

Other known operating room assistance systems enhance the practice of medicine through the use of portable stands that can be used with an adjustably positioned camera and a lighting unit. Further, some systems include a remotely-controlled video camera and light source that may share the same optical path, both of which are mounted on an articulating boom for video-imaging, videoconferencing, production and recording. Such units provide camera angles and lighting paths to improve interactive video and data production and communications capabilities between hospital operating room/procedure room environments and other remote locations for surgical/medical device assistance and demonstration, education, and consultation.

Still, as the resolution and recording capabilities of both pan-tilt-zoom cameras and tablet personal computers continue to improve over time, and as Internet and Wi-Fi connectivity speeds continue to increase, there is more need for these portable stands to provide a connectivity point for communication and data transfer services in the operating room.

Accordingly, there is a need for a portable, floor standing console with articulating arms for positioning a video camera and tablet personal computer around an operating table that can be readily mobilized on the floor of an existing operating room and is capable of providing a connectivity point for communication, audiovisual, and data transfer services in the operating room.

### SUMMARY n

This disclosure relates to a mobile floor standing console, which includes a wheeled base, a lower rack mounted on the base, an upper rack extending vertically from the lower rack, a first articulating arm that is configured to extend outward away from the upper rack and collapse inward toward the upper rack, and a second articulating arm that is configured to extend outward away from the upper rack and collapse inward toward the upper rack.

The floor standing console as disclosed provides a number of advantages, including peri-operative medical device support in the operating room, improved viewing angles and shorter distances for doctors and others who are viewing remotely via the electronic display.

The use of the console also provides for a controlled sterile environment by restricting physical access to the operating room. Medical device sales representatives will no longer need access to patient care areas, but will instead gain access to the patient and patient care areas through a secure digital platform. In addition, the console may be used for remote medical device support, physician proctoring or any other educational, training or clinical support, in which a third-party requires autonomy in remotely visualizing and providing surgical and anatomical guidance.

Since the portable console can be maneuvered around the operating table there is no need for the use of ceiling booms to suspend equipment or the ceiling booms can be reserved for larger equipment that is otherwise too heavy to be supported by a floor standing unit.

Another advantage includes gesture-based control of the pan-tilt-zoom camera for both the users in the operating room and the remote users can manipulate through the use of the tablet device. In addition, the console provides the ability for users in the operating room and remote user to manipulate the flow of video, audio and data by toggling of video sources, selection of audio output source and selection of data sources.

Further, the stand portion of the unit can be used to store electronic equipment and it provides a centralized on board computer that can be readily accessed by the surgeon and medical staff. The floor standing console can also be configured to deliver power and electronic connectivity to equipment.

It should be understood that the summary above is provided to introduce in simplified form a selection of examples that are further described in the detailed description. It is not meant to identify key or essential features of any claimed subject matter that may later claim priority to the present description. Furthermore, the scope of any such claimed subject matter would not be limited to implementations that solve any disadvantages noted above or contained herein.

### BRIEF DESCRIPTION OF THE DRAWINGS

Many aspects of the present invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a top, front side, isometric view of a floor standing unit, according to embodiments of the invention.

FIG. 2 is a top, back side, isometric view of the unit shown in FIG. 1, according to embodiments of the invention.

FIG. 3 is a close up view of the inside of the storage, power, and connectivity compartment shown in FIG. 2, according to embodiments of the invention.

### DETAILED DESCRIPTION

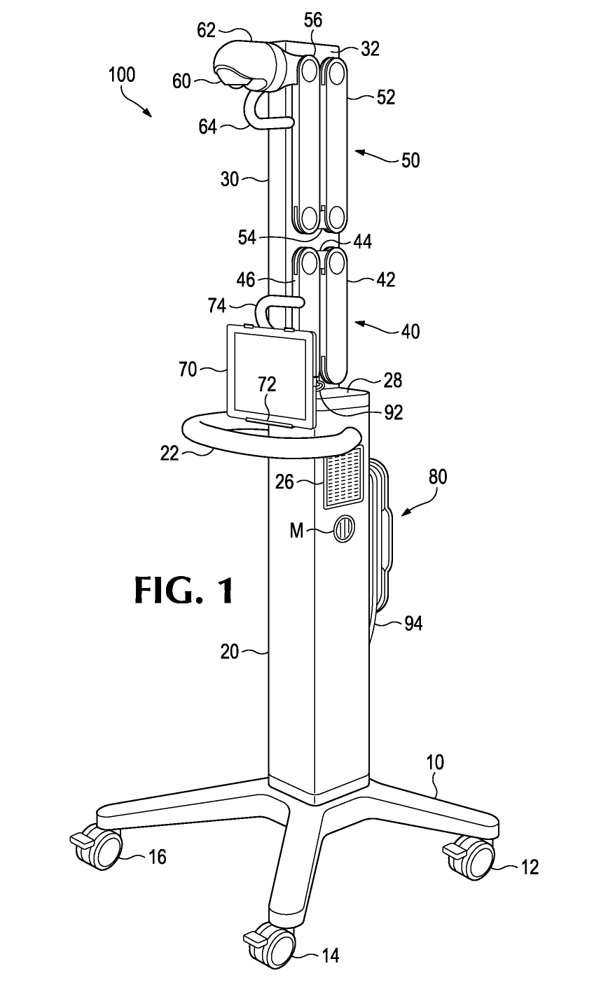

The embodiments in this disclosure, as illustrated in FIGS. 1 through 3 and described in the text below, are adapted for use in operating room during surgical procedures, including, but not limited to, orthopedic and spinal procedures.

The term electronic display shall mean an electronic visual display, informally a screen, and a display device for presentation of images, text, or video transmitted electronically, without producing a permanent record. Electronic visual displays may include television sets, computer monitors, tablet computers, smartphones, and information appliances.

The term on-board computer shall mean and represent practically any type of computer, computer system or other programmable electronic device having mobile computing capabilities, including a personal computer, a tablet computer, Personal Digital Assistant (PDA), Personal Information Manager (PIM), cellular telephone, smartphone, and the like.

With more detailed reference to FIGS. 1 through 3, reference numeral label 100 designates the floor standing unit or vertical console. Unit 100 has a base 10 with lockable swivel caster-wheels 12, 14, 16, and 18, a lower rack 20, an upper rack 30, articulating arms 40 and 50, pan-tilt-zoom camera 60, electronic display 70, compartment 80, and an on-board computer 90.

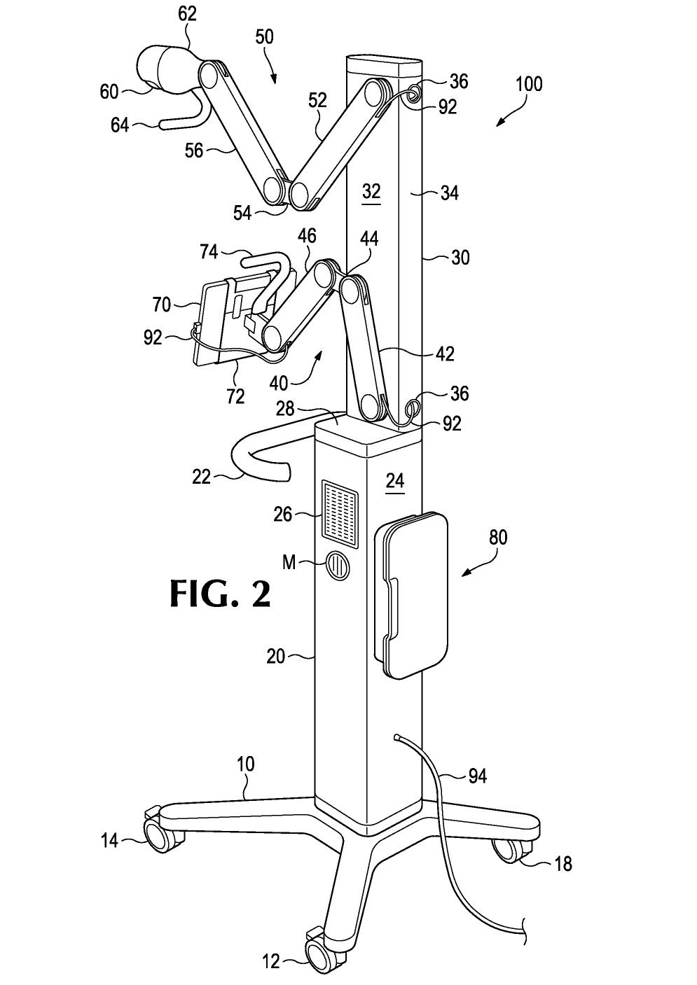

in one embodiment, FIG. 1 illustrates the unit 10 having base 10 and lockable, swivel caster wheels 12, 14, and 16. The base 10 may be made with tube metal or any other suitable material that can be used in a sterile environment such as an operating room. In a non-limiting embodiment, four rolling lockable caster wheels are used with the base 10. Three wheels 12, 14, and 16 are shown in FIG. 1, while the fourth wheel 18 is shown in FIG. 2.

It should be appreciated by those of ordinary skill that the specific structural and material configurations of the base 10 and caster wheels 12, 14, 16, and 18 are exemplary only. Other design configurations and any number of caster wheels may be used that generally fall within the spirit and scope of the present disclosure.

With continuing reference to FIG. 1, base 10 is connected to lower rack 20. The lower rack 20 can be made with tube metal or any other suitable material that can be used in a sterile environment such as an operating room. The lower rack 20 includes handle 22, which may be used to maneuver the console 100 via caster wheels 12, 14, 16, and 18. The handle 22 attaches to the stand 20 on one end with the other end being open-ended and configured to receive sterile sleeves (not shown) as may be necessary to protect the sterile environment.

In another embodiment, the lower rack 20 can be of a hollow construction to allow placement of a built-in speaker 26 and a built-in microphone M. Any type and quantity of audio speakers 26 and microphones M that are sized appropriately to fit within the lower rack 20 can be used. The speaker 26 may be connected to the power supply 94 and 96 (which will be described later herein) and communicate with the electronic device 70 through Bluetooth® technology.

Lower rack 20 includes a back side 24 to gain entry to the hollow construction and for positioning storage compartment 80, which will be described later herein. Shelf 28 is positioned atop the lower rack 20.

Next, with reference to FIG. 2 and continuing reference to FIG. 1, upper rack 30 is illustrated. Upper rack 30 can be made with tube metal or any other suitable material that can be used in a sterile environment such as an operating room. The upper rack 30 can be constructed to be hollow, as well. The upper rack 30 includes sidewall 32 and back wall 34 which is configured to be in a plane perpendicular to the plane of sidewall 32. Back wall 34 also includes holes 36 (two exemplary holes are shown in FIG. 2) in which to run wire 92, which will be described later herein.

In a non-limiting embodiment, articulating arms 40 and 50 are shown in FIGS. 1 and 2. The arms 40 and 50 are positioned in the same vertical plane with the top arm 50 positioned above the lower arm 40 and each arm attached to the same sidewall 32 of the upper rack 30.

The lower articulating arm 40 includes first segment 42 attached to the sidewall 32 of the upper rack 30 on the proximal end of the first segment 42. Joint 44 connects the first segment 42 with a second segment 46. The top articulating arm 50 is configured to be placed above arm 40 with both arms 40 and 50 configured to be in the same vertical plane. Similar to articulating arm 40, articulating arm 50 includes first segment 52 attached to the sidewall 32 of the upper rack 30 on the proximal end of the first segment 52, and a joint 54, which connects the first segment 52 to second segment 56.

It should be appreciated by those of ordinary skill that the specific structural and material configurations of articulating arms 40 and 50 are exemplary only. Other design configurations and any number of arms may be used that generally fall within the spirit and scope of the present disclosure.

Articulating arms 40 and 50 are extendable as shown in FIG. 1 and collapsible as shown in FIG. 2. The articulating arms 40 and 50 can have more than one joint 44 and 54. The joints 44 and 54 may be friction joints or another type of joint that will allow articulation of the arms 40 and 50, and the arms 40 and 50 can be constructed to be hollow.

With continuing reference to FIG. 1 and FIG. 2, a pan-tilt-zoom camera 60 is attached to the distal end of articulating arm 50. Any conventional pan-tilt-zoom camera 60 can be used. In a non-limiting embodiment, a rotational fastener 62 connects the pan-tilt-zoom camera 60 to articulating arm 50. Camera handle 64 can be used to actuate the rotation of the camera 60, as well as maneuver (extend or collapse) the articulating arm 50. Camera handle 64 via arm 50 is also capable of helping to angle the camera 60 in a field of view over the electronic device 70. Similar to handle 22, the camera handle 64 attaches to the upper rack 30 on one end with the other end being open-ended and configured to receive sterile sleeves (not shown) as may be necessary to protect the sterile environment.

In another embodiment, articulating arm 40 includes an electronic display 70. In one exemplary embodiment, the electronic display 70 is a tablet computer with a mobile application installed for connection to the Internet over Wi-Fi or 4G, allowing operating room personnel to communicate securely with personnel who are in a remote location.

Still referring to FIGS. 1 and 2, frame 72 holds the electronic display 70 in adjustable positions for viewing and touch-screen access. The frame 72 is designed such that the tablet or electronic display 70 may be easily removed from the frame 72. Frame 72 may have any number of pivot axes with an exemplary embodiment having a horizontal and vertical pivot axis (See FIG. 2). The frame 72 includes an open-ended, electronic display handle 74. Electronic display handle 74 is attached to the frame 72 on one end with the other end being open-ended and configured to receive sterile sleeves (not shown) as may be necessary to protect the sterile environment.

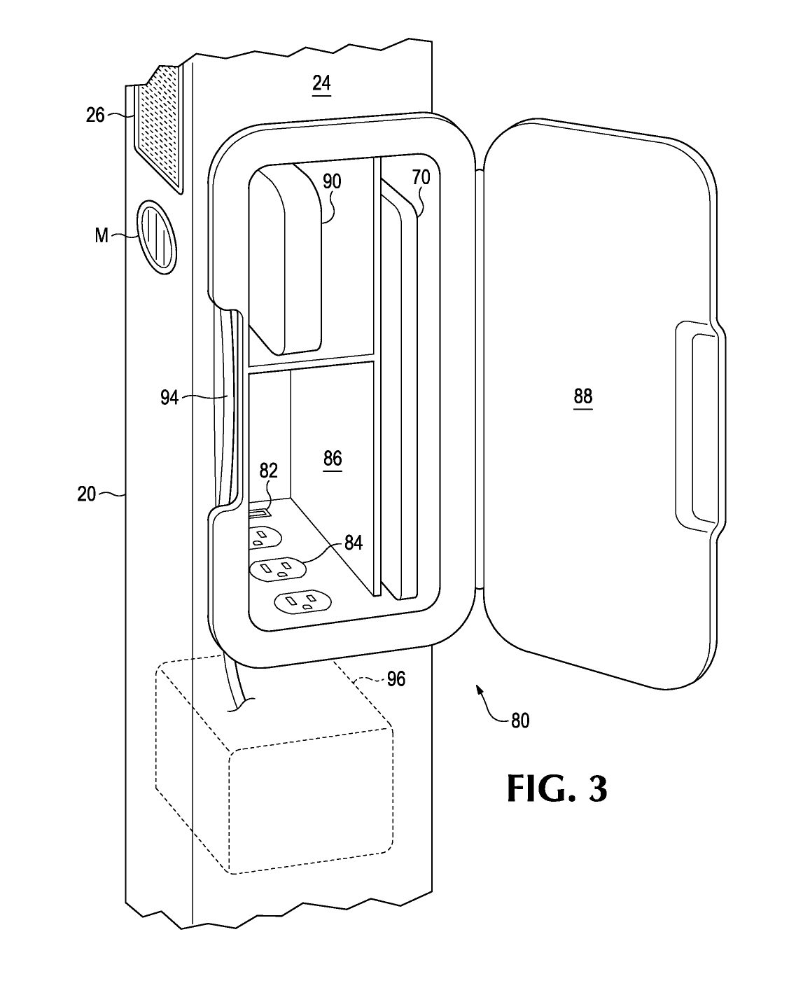

Referring now to FIG. 3, storage compartment 80 is illustrated. The storage compartment 80 may also serve as a cable wrap for the power supply cable 94. Storage compartment 80 includes door 88 to protect the contents. Divider 86 is provided for storing the on-board computer 90 (which will be described later herein) and electronic display 70, as well as providing a compartment for the universal serial bus (USB) port 82 (one port is shown), and power outlets 84 (three exemplary power outlets are shown). It should be appreciated by those of ordinary skill that other exemplary configurations and positioning of the divider 86 fall within the spirit and scope of the present disclosure. In addition, any number of ports 82 and power outlets 84 may be used that generally fall within the spirit and scope of the present disclosure.

The on-board computer 90 may receive power by connecting to the power supply 94. (See FIG. 1). In another non-limiting embodiment, there may also be a battery pack 96 to charge the connected components when the power cable 94 is not connected to a wall mounted, power outlet (not shown). Wiring 92 may be used to power other components, such as the camera 60 and electronic display 70 that are housed in the upper rack 30. (See FIGS. 1 and 2).

On-board computer 90 typically includes at least one processor (not shown) coupled to a memory (not shown). Processor herein may represent one or more processors (e.g. microprocessors), and memory herein may represent random access memory (RAM) devices comprising a main storage of computer 90, as well as any supplemental levels of memory, e.g., cache memories, non-volatile or back-up memories (e.g. programmable flash memories), read-only memories, etc. In addition, memory may be considered to include memory storage physically located elsewhere in computer 90 e.g. any cache memory in a processor, as well as any storage capacity used as a virtual memory, e.g. as stored on a mass storage device (not shown) or on another computer (not shown) coupled to computer 90 via the Internet or a network (not shown).

The on-board computer 90 also typically receives a number of inputs and outputs for communicating information externally. For interface with a user or operator, including doctors and medical staff, the on-board computer 90 typically includes one or more user-input devices (e.g.; a keyboard (not shown), a mouse (not shown), a microphone M, or a tablet 70 and an output unit or display 70 (e.g.; an LCD display panel).

With respect to FIGS. 1 through 3, the pan-tilt-zoom camera 60 can be connected to the on-board computer 90 for transmitting a video stream (not shown) to the on-board computer 90. In addition, the on-board computer 90 can be capable of converting the video stream to an encrypted stream (not shown) that may consist of, for example, 128-bit advanced encryption standard. The video stream may be communicated from the on-board computer 90 through the Internet to a remote user via the electronic display 70.

The instant invention may be embodied in other forms or carried out in other ways without departing from the spirit or essential characteristics thereof. The present disclosure is therefore to be considered as in all respects illustrative and not restrictive, the scope of the invention being indicated by the appended claims, and all equivalency are intended to be embraced therein. One of ordinary skill in the art would be able to recognize equivalent embodiments of the instant invention and be able to practice such embodiments using the teaching of the instant disclosure and only routine experimentation.

What is claimed is:

1. A mobile, vertical, floor standing console for use in a healthcare facility, comprising:
a wheeled. base;
a lower rack mounted on the base;
an upper rack having at least one sidewall, the upper rack extending vertically from the lower rack;
a first articulating arm, the first arm configured to attach to the at least one sidewall of the upper rack and extend outward away from the upper rack and collapse inward along the at least one sidewall of the upper rack;
a second articulating arm, the second arm configured in the same vertical plane as the first arm, the second arm is configured to attach to the at least one sidewall of the upper rack and extend outward away from the upper rack and collapse inward along the at least one sidewall of the upper rack above the first arm;
a pan-tilt-zoom camera for producing live video images, the camera connected to a distal end of the second articulating arm;
an electronic display connected to a distal end of the first articulating arm;
an on-board computer housed in the lower rack; and, a power supply;
the console wherein, the video images are delivered and transferred to a different healthcare facility, and
the console wherein, the video images are delivered and transferred within the healthcare facility.

2. The console of claim 1, wherein the electronic display is a tablet computer.

3. The console of claim 1, wherein the pan-tilt-zoom camera is angled via the second articulating arm to produce the live video images on the electronic display.

4. The console of claim 1, wherein the first articulating arm includes a first segment and a second segment with a joint therebetween.

5. The console of claim 1, wherein the second articulating arm includes a first segment and a second segment with a joint therebetween.

6. The console of claim 1, wherein the console may be wheeled into a convenient location in an operating room or near the patient and surgical field.

7. The console of claim 1, wherein the console comprises at least one display for displaying outputs from the pan-tilt-zoom camera.

8. The console of claim 1, wherein the video images are delivered and transferred via the Internet.

9. A vertical, mobile communications console, comprising:
a wheeled base;
a lower rack mounted on the base;
an upper rack having at least one sidewall, the upper rack extending vertically from the lower rack;
a first articulating arm, the first arm configured to attach to the at least one sidewall of the upper rack and extend outward away from the upper rack and collapse inward along the at least one sidewall of the upper rack;
a second articulating arm, the second arm configured in the same vertical plane as the first arm, the second arm is configured to attach to the at least one sidewall of the upper rack and extend outward away from the upper rack and collapse inward along the at least one sidewall of the upper rack above the first arm;
a remote controlled pan-tilt-zoom camera connected to a distal end of the second articulating arm;
a tablet computer connected to a distal end of the first articulating arm; and,
an on-board computer housed in the lower rack for mixing, producing, and recording video feeds from the pan-tilt-zoom camera and the tablet computer and for network conferencing of a video production in real time; and,
a rechargeable battery power supply.

10. The console of claim 9, wherein the remote controlled pan-tilt-zoom camera produces live video images.

11. The console of claim 10, wherein the remote controlled pan-tilt-zoom camera is angled via the second articulating arm to produce the live video images on the tablet computer.

12. The console of claim 9, wherein the console may be wheeled into a convenient location in an operating room or near the patient and surgical field.

13. The console of claim 9, wherein the console comprises at least one display for displaying outputs from the remote controlled pan-tilt-zoom camera.

14. The console of claim 9, wherein the video feeds are delivered and transferred via the Internet.

15. A vertical standing, mobile communications console for use during surgery, comprising:
an electronic display; and
an audiovisual component in communication with the electronic display for providing visual content to the electronic display and in communication with a speaker component for providing auditory content to the speaker component in conjunction with the visual content.

16. The console of claim 15, wherein the electronic display is a tablet computer.

17. The console of claim 15, wherein the audiovisual component is a pan-tilt-zoom camera having a microphone.

18. The console of claim 15, wherein the console comprises a stand-alone speaker and a stand-alone microphone.

19. The console of claim 15, wherein the console comprises an on-board computer in communication with the electronic display and audiovisual component for network conferencing of the video content and audio content in real time.

20. The console of claim 15, wherein the video content and audio content are delivered and transferred via the Internet.
